(19) United States
(12) Patent Application Publication
(10) Pub. No.: US 2025/0068729 A1
(43) Pub. Date: Feb. 27, 2025

(54) ULTRA-LIGHT CLUSTERING-BASED GENERATIVE INTRUSION DETECTION DEVICE AND METHOD, AND COMPUTER-READABLE RECORDING MEDIUM INCLUDING INSTRUCTIONS TO PERFORM METHOD

(71) Applicant: KOOKMIN UNIVERSITY INDUSTRY ACADEMY COOPERATION FOUNDATION, Seoul (KR)

(72) Inventors: Myung Keun YOON, Seoul (KR); HyungBin SEO, Seoul (KR)

(73) Assignee: KOOKMIN UNIVERSITY INDUSTRY ACADEMY COOPERATION FOUNDATION, Seoul (KR)

(21) Appl. No.: 18/787,269

(22) Filed: Jul. 29, 2024

(30) Foreign Application Priority Data
Aug. 23, 2023 (KR) 10-2023-0110549

(51) Int. Cl. G06F 21/55

(52) U.S. Cl. CPC G06F 21/554; G06F 2221/034

(57) ABSTRACT

An ultra-light clustering-based generative intrusion detection device, includes: a data receiver configured to receive a data stream containing a specific type of data; a big-group identification unit configured to identify at least one big-group related to similar data encoded as a virtual vector based on a chunk set for each piece of data of the data stream; and a signature generator configured to extract signatures for each of the at least one big-group and generate a signature group

### CROSS-REFERENCE TO PRIOR APPLICATION

This Application claims priority to Korean Patent Application No. 10-2023-0110549 (filed on Aug. 23, 2023), which is hereby incorporated by reference in its entirety.

### ACKNOWLEDGEMENT

### National Research Development Project Supporting the Present Invention

Project Serial No.: 1711187406
Project No.: A2023-0186
Department: Ministry of Science and ICT, Republic of Korea
Project management (Professional) Institute: National Research Foundation of Korea
Research Project Name: Personal Basic Research (Ministry of Science and ICT)
Research Task Name: Research on Generative Security Technology for Zero-day Defense
Contribution Ratio: 1/1
Project Performing Institute: Kookmin University
Research Period: 2023.03.01 ˜ 2024.02.29

### BACKGROUND

The present disclosure relates to ultra-light clustering-based generative intrusion detection technology, and more specifically, to a new streaming algorithm capable of achieving high detection accuracy with only a small amount of fixed memory and a specific hash operation by identifying frequent signature groups that appear simultaneously in a data stream.

One of the most important tasks in cybersecurity can be collecting and analyzing data generated in various security products, networking components, servers, and user endpoints. The data may correspond to security events or alerts caused by monitoring devices, network packets, e-mails, suspicious files, etc. Such data can often be collected by a security operations center (SOC) where security analysts perform real-time monitoring and manual analysis of critical data.

Recent studies have shown that security alerts can occur in large numbers, overwhelming human resources performing security tasks. For example, while more than a million alerts are generated per day, there may be at most a few dozen people working on alert analysis. Therefore, intelligent and automatic data analysis tools can be essential for security tasks.

Attack detection can be performed by manually creating signatures, simple strings, or regular expressions by experts and then relying on signature matching. This signature-based detection can cause many problems in that it no longer effectively mitigates attacks. Accordingly, many machine learning (ML)-based approaches for anomaly detection are being developed in the cybersecurity field, but machine learning can inherently generate false positives that are incorrectly regarded as attacks.

### Prior Art Document

Korean Patent Publication No. 10-2015-0133498 (Nov. 30, 2015)

### SUMMARY

An object of an embodiment of the present disclosure is to provide an ultra-light clustering-based generative intrusion detection device and method capable of achieving high detection accuracy with only a small amount of fixed memory and a certain hash operation by identifying frequent signature groups that appear simultaneously in a data stream.

In embodiments, an ultra-light clustering-based generative intrusion detection device includes a data receiver configured to receive a data stream containing a specific type of data, a big-group identification unit configured to identify at least one big-group related to similar data encoded as a virtual vector based on a chunk set for each piece of data of the data stream, and a signature generator configured to extract signatures for each of the at least one big-group and generate a signature group.

The data receiver may receive a data stream with respect to any one of a plurality of types including an alert, a log, a packet, an e-mail, and a file.

The big-group identification unit may include a minhashed virtual-vector (MV2) module configured to generate the virtual vector represented as a bitmap based on a minimum value of each hash function by applying a different hash function to each chunk of the chunk set, and a Jaccard-index grouping (JIG) module configured to determine the similar data classified as the big-group based on a big-counter derived by accumulating the virtual vector in a fixed-size counter array.

The JIG module may determine a counter exceeding a preset first threshold value among counters in the counter array as the big-counter.

The JIG module may calculate a proportion of the big-counter within the counter array and determine data associated with the virtual vector as the similar data when the proportion exceeds a preset second threshold value.

The JIG module may repeatedly perform a first step of calculating an average and variance of counters in the counter array excluding counters in a big-counter set in a state in which the big-counter has been initialized, and a second step of adding counters calculated based on the average and variance and exceeding the first threshold value to the big-counter set to determine a counter in the big-counter set as the big-counter.

The JIG module may calculate the first threshold value through the following expression based on the average and variance.

$${θ}_{C , i} = {μ}_{i} + c \times {σ}_{i} \qquad [ Expression ]$$

(Here, θ_{C,i} is the first threshold value, μᵢ and σᵢ are the average and variance, respectively, and c is a tuning parameter.)

The MV2 module may change k bit values of the bitmap to 1 using k different hash functions (where k is a natural number).

The signature generator may include a signature-group generation (SG2) module configured to generate the signature group for each cluster by applying a clustering algorithm to the similar data identified as the at least one big-group, and an automatic whitelisting (AWL) module configured to remove normal signatures in a white list from the signature group.

The AWL module may generate the white list by extracting the normal signatures from a data set that is not identified as the at least one big-group among the data of the data stream.

In embodiments, an ultra-light clustering-based generative intrusion detection method performed by an intrusion detection device includes receiving, by a data receiver, a data stream containing a specific type of data, identifying, by a big-group identification unit, at least one big- group related to similar data encoded as a virtual vector based on a chunk set for each piece of data of the data stream, and generating, by a signature generator, a signature group by extracting signatures for each of the at least one big-group.

The identifying at least one big-group may include generating, by a minhashed virtual- vector (MV2) module, the virtual vector represented as a bitmap based on a minimum value of each hash function by applying a different hash function to each chunk of the chunk set, and determining, by a Jaccard-index grouping (JIG) module, the similar data classified as the big-group based on a big-counter derived by accumulating the virtual vector in a fixed-size counter array.

The determining the similar data may include determining a counter exceeding a preset first threshold value among counters in the counter array as the big-counter.

The determining as the big-counter may include a first step of initializing a big-counter set, a second step of calculating an average and variance of counters in the counter array excluding counters in the big-counter set, a third step of adding counters calculated based on the average and variance and exceeding the first threshold value to the big-counter set, and a fourth step of determining a counter in the big-counter set as the big-counter by repeatedly performing the second and third steps until no new counter is inserted into the big-counter set.

In embodiments, a computer-readable recording medium storing a computer program including instructions for performing an intrusion detection method including receiving a data stream containing a specific type of data, identifying at least one big-group related to similar data encoded as a virtual vector based on a chunk set for each piece of data of the data stream, and generating a signature group by extracting signatures for each of the at least one big-group.

The disclosed technology can have the following effects. However, since it does not mean that a specific embodiment must include all of the following effects or only the following effects, the scope of rights of the disclosed technology should not be understood as being limited thereby.

The ultra-light clustering-based generative intrusion detection device and method according to an embodiment of the present disclosure can alleviate a large number of false detection signatures due to group signature generation, optimize time and space complexity through high-speed minimum hash operation and clustering in data streams, operate automatically without human intervention, and operate on various strings, network packets, malware, and set-based data.

### BRIEF DESCRIPTION OF THE DRAWINGS

FIG. 1 is a diagram illustrating an intrusion detection system according to the present disclosure.

FIG. 2 is a diagram illustrating a system configuration of an intrusion detection device of FIG. 1.

FIG. 3 is a diagram illustrating a functional configuration of the intrusion detection device of FIG. 1.

FIG. 4 is a flowchart illustrating an ultra-light clustering-based generative intrusion detection method according to the present disclosure.

FIG. 5 is a diagram illustrating a virtual vector generation process of an MV2 module according to the present disclosure.

FIG. 6 is a diagram illustrating a minimum hash calculation process according to the present disclosure.

FIG. 7A to FIG. 7G are diagrams illustrating a big group identification process of a JIG module according to the present disclosure.

FIG. 8 is a diagram illustrating a signature generation process of an SG2 module according to the present disclosure.

FIG. 9 is a diagram illustrating an additional filtering process of an AWL module according to the present disclosure.

### DETAILED DESCRIPTION

The explanation of the present disclosure is merely an embodiment for structural or functional explanation, so the scope of the present disclosure should not be construed to be limited to the embodiments explained in the embodiment. That is, since the embodiments may be implemented in several forms without departing from the characteristics thereof, it should also be understood that the described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

Terms described in the present disclosure may be understood as follows.

While terms such as “first”, “second”, etc., may be used to describe various components, such components must not be understood as being limited to the above terms. The above terms are used to distinguish one component from another. For example, a first component may be referred to as a second component without departing from the scope of rights of the present disclosure, and likewise a second component may be referred to as a first component.

It will be understood that when an element is referred to as being “connected to” another element, it may be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising” will be understood to imply the inclusion of stated elements but not the exclusion of any other elements. Meanwhile, other expressions describing relationships between components such as “between”, “immediately between” or “adjacent to” and “directly adjacent to” may be construed similarly.

Singular forms “a”, “an” and “the” in the present disclosure are intended to include the plural forms as well, unless the context clearly indicates otherwise. It will be further understood that terms such as “including” or “having”, etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

In each phase, reference numerals (for example, a, b, c, etc.) are used for the sake of convenience in description, and such reference numerals do not describe the order of each phase. The order of each phase may vary from the specified order, unless the context clearly indicates a specific order. In other words, each phase may take place in the same order as the specified order, may be performed substantially simultaneously, or may be performed in a reverse order.

The present disclosure may be implemented as machine-readable codes on a machine-readable medium. The machine-readable medium may include any type of recording device for storing machine-readable data. Examples of the machine-readable recording medium may include a read-only memory (ROM), a random access memory (RAM), a compact disk-read only memory (CD-ROM), a magnetic tape, a floppy disk, optical data storage, or any other appropriate type of machine-readable recording medium. The medium may also be carrier waves (for example, Internet transmission). The computer-readable recording medium may be distributed among networked machine systems which store and execute machine-readable codes in a de-centralized manner.

The terms used in the present application are merely used to describe particular embodiments, and are not intended to limit the present disclosure. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present application.

Variables used here can be defined as shown in Table 1 below.

TABLE 1

| Variable | Description |
|---|---|
| dᵢ | i-th data of a data stream |
| CDC(dᵢ) | Set of chunks derived from dᵢ |
| j(dᵢ, dⱼ) | Jaccard index between CDC(dᵢ) and CDC(dⱼ) |
| Bᵢ[m] | Bitmap representing dᵢ |
| MV[m] | Array of integers summarizing a data stream |
| θ_{J} | Threshold value for similarity between two pieces of data |
| θ_{B} | Threshold value for big data identification |
| θ_{C, i} | Threshold value for big counter of dᵢ for MV [m] |

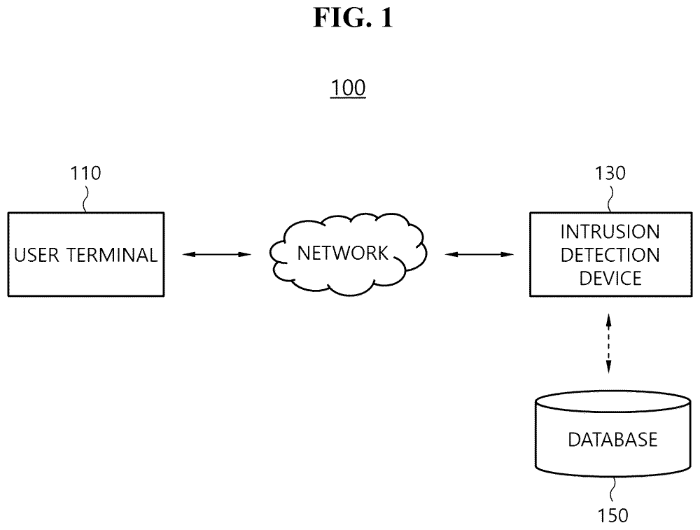

Referring to FIG. 1, an intrusion detection system 100 may include a user terminal 110, an intrusion detection device 130, and a database 150.

The user terminal 110 may correspond to a computing device capable of transmitting data and using various services using a network and may be implemented as a smartphone, a laptop computer, or a computer. However, the user terminal 110 is not necessarily limited thereto and may be implemented as various devices such as a tablet PC.

In addition, the user terminal 110 may be implemented as a device constituting the intrusion detection system 100 according to the present disclosure, and the intrusion detection system 100 may be implemented by being modified into various forms depending on the purpose of ultra-light clustering-based generative intrusion detection.

The user terminal 110 may be connected to the intrusion detection device 130 through a network, and a plurality of user terminals 110 may be connected to the intrusion detection device 130 simultaneously. For example, the user terminal 110 may correspond to a target device for network packet monitoring.

The intrusion detection device 130 may be implemented as a server that executes a computer or a program for performing an ultra-light clustering-based generative intrusion detection method according to the present disclosure. Here, the ultra-light clustering-based generative intrusion detection method according to the present disclosure may correspond to a new detection and prevention method for mitigating specific types of zero-day attacks including duplicate similar data.

That is, the intrusion detection device 130 may identify similar data groups in a large data streams and automatically extract signature groups that appear simultaneously in the identified groups. The intrusion detection device 130 can significantly reduce false positives in intrusion detection by generating a group of signatures instead of a single signature. In addition, the ultra-light clustering-based generative intrusion detection method according to the present disclosure may correspond to new type of generative intrusion detection and prevention on data stream (GIPS) since an operation of identifying similar data groups and an operation of generating signature groups are automatically performed for data streams.

Additionally, the intrusion detection device 130 may be connected to the user terminal 110 through a wired network or a wireless network such as Bluetooth, Wi-Fi, or LTE, and may transmit/receive data to/from the user terminal 110 through the network. Additionally, the intrusion detection device 130 may be implemented to operate in connection with an independent external system (not shown in FIG. 1).

The database 150 may correspond to a storage device that stores various types of information required during the operation of the intrusion detection device 130. The database 150 may store e-mails, packets, and files collected from data streams and store various rules and signature information for attack detection, but is not necessarily limited thereto and may store information collected or processed in various forms when the intrusion detection device 130 performs ultra-light clustering-based generative intrusion detection processing.

Although FIG. 1 shows that the database 150 is a device independent of the intrusion detection device 130, the database 150 is not necessarily limited thereto and may be implemented as a logical storage device included in the intrusion detection device 130.

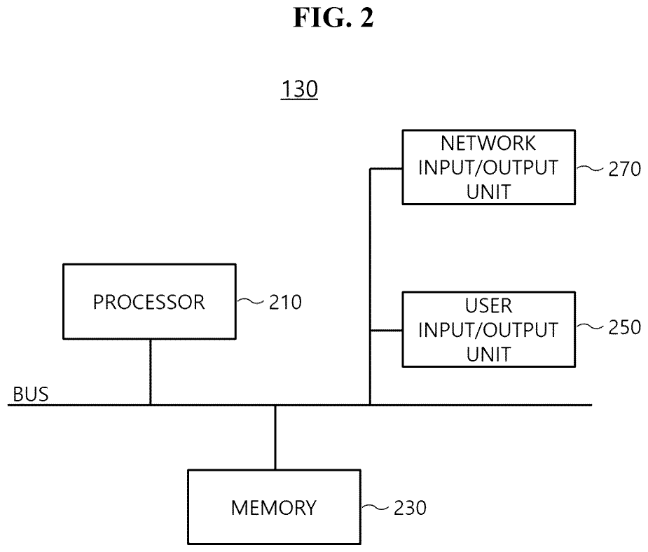

FIG. 2 is a diagram illustrating a system configuration of the intrusion detection device of FIG. 1.

Referring to FIG. 2, the intrusion detection device 130 may include a processor 210, a memory 230, a user input/output unit 250, and a network input/output unit 270.

The processor 210 can execute an ultra-light clustering-based generative intrusion detection procedure according to an embodiment of the present disclosure, manage the memory 230 from/in which data is read or written in the procedure, and schedule synchronization time between a volatile memory and a non-volatile memory included in the memory 230. The processor 210 may control the overall operation of the intrusion detection device 130 and may be electrically connected to the memory 230, the user input/output unit 250, and the network input/output unit 270 to control data flows therebetween. The processor 210 may be implemented as a central processing unit (CPU) or a graphics processing unit (GPU) of the intrusion detection device 130.

The memory 230 may include an auxiliary memory that is implemented as a non-volatile memory such as a solid state disk (SSD) or a hard disk drive (HDD) and used to store data required for the intrusion detection device 130 and a main memory implemented as a volatile memory such as a random access memory (RAM). In addition, the memory 230 may store a set of instructions for executing the ultra-light clustering-based generative intrusion detection method according to the present disclosure by being executed by the processor 210 electrically connected thereto.

The user input/output unit 250 includes an environment for receiving user input and an environment for outputting specific information to a user, and for example, may include an input device including an adapter such as a touch pad, a touch screen, an on-screen keyboard, or a pointing device and an output device including an adapter such as a monitor or a touch screen. In one embodiment, the user input/output unit 250 may correspond to a computing device connected through remote connection, and in such a case, the intrusion detection device 130 may serve as an independent server.

The network input/output unit 270 provides a communication environment for connection to the user terminal 110 through a network and may include an adapter for communication such as a local area network (LAN), a metropolitan area network (MAN), a wide area network (WAN), and a value added network (VAN), for example. Additionally, the network input/output unit 270 may be implemented to provide short-range communication functions such as Wi-Fi and Bluetooth or wireless communication functions of 4G or higher for wireless data transmission.

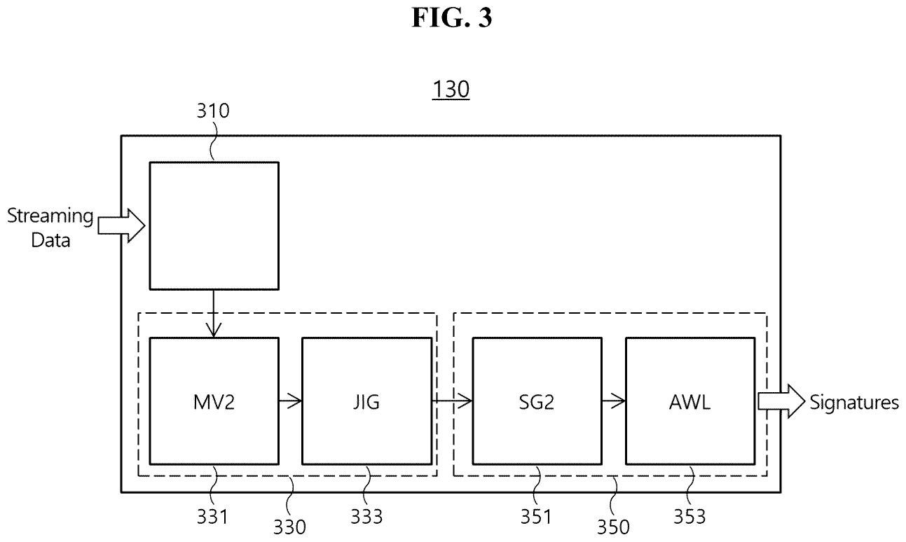

FIG. 3 is a diagram illustrating the functional configuration of the intrusion detection device of FIG. 1.

Referring to FIG. 3, the intrusion detection device 130 can perform the ultra-light clustering-based generative intrusion detection method according to the present disclosure. To this end, the intrusion detection device 130 may include a data receiver 310, a big-group identification unit 330, a signature generator 350, and a controller (not shown in FIG. 3).

Here, the embodiment of the present disclosure does not need to include all of the above components simultaneously, and some of the above components may be omitted or some or all of the above components may be selectively included depending on each embodiment. Hereinafter, the operation of each component will be described in detail.

The data receiver 310 may receive a data stream containing a specific type of data. A data stream may correspond to a flow of data and may correspond to a set of data transmitted through a network. In one embodiment, the data receiver 310 may receive data streams of any one of a plurality of types including an alert, a log, a packet, an e-mail, and a file. For example, the data receiver 310 may operate in association with a communication module for network communication to receive a data stream, receive network packets transmitted or received during a network communication process, and store the network packets in the memory 230 or the database 150.

Additionally, the data receiver 310 may preprocess the received data and convert the preprocessed data into data that can be used in the next step. For example, after receiving network packets, the data receiver 310 may extract and store only a packet payload for each packet. A network packet may include a packet header and a packet payload, and the packet payload may include control information and user data.

Additionally, the data receiver 310 may receive a packet file including a network packet. For example, the data receiver 310 may receive a “.pcap” file. The data receiver 310 may perform preprocessing operations such as packet filtering and packet parsing.

The big-group identification unit 330 may identify at least one big-group related to similar data encoded as a virtual vector based on a set of chunks for each piece of data in a data stream. That is, the big-group identification unit 330 can classify similar data in a data stream by grouping the same into a big group. Here, a big-group may correspond to a set of similar data including new data when the ratio of the number of pieces of similar data to the total number of pieces of data is greater than a predefined threshold value for the new data.

In one embodiment, the big-group identification unit 330 may include independent modules that perform operations for big-group identification. That is, the big-group identification unit 330 may include a Minhashed Virtual-Vector (MV2) module 331 and a Jaccard-Index Grouping (JIG) module 333. Here, the big-group identification unit 330 according to an embodiment of the present disclosure does not need to include all of the above modules simultaneously, and depending on each embodiment, some of the above modules may be omitted or some or all of the above modules may be selectively included.

The MV2 module 331 may apply a different hash function to each chunk of a chunk set and generate a virtual vector represented as a bitmap based on the minimum value of each hash function. Here, a chunk set may be created for each piece of data in a data stream and may correspond to a set of chunks extracted from the data. For example, a chunk set may correspond to a set of strings. That is, since a chunk is determined according to the type of data being extracted, a chunk set may include various types of chunks. The chunk set may be created in the preprocessing step of the data receiver 310 or may be directly created by the MV2 module 331.

For example, if the original data type is already a set, such as a set of ASCII strings extracted from a malware file, the data can be used as a chunk set as is. Otherwise, that is, in the case of a network packet with a byte sequence less than 1600 bytes in a transport layer, a chunk set may be created as a result of extraction of a plurality of words or tokens from the data. As another example, if necessary, Content-Defined Chunking (CDC) may be applied to convert a byte sequence into a set of chunks in the form of a set of strings.

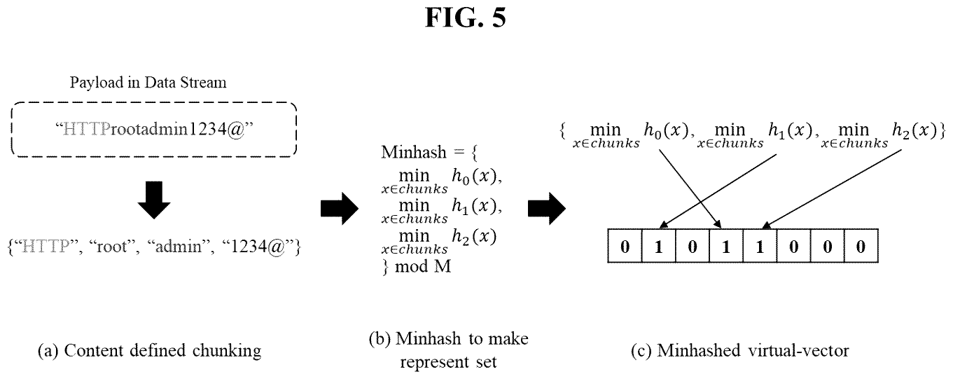

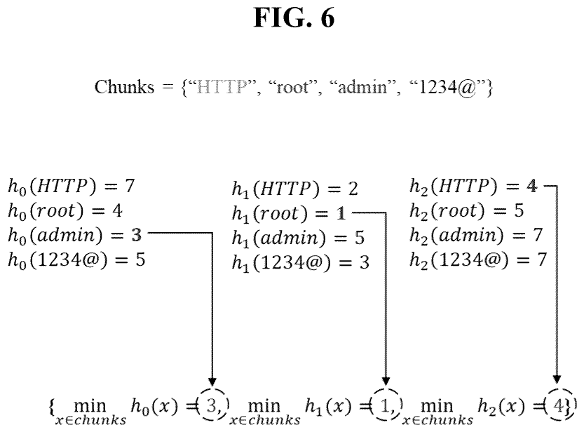

In one embodiment, the MV2 module 331 may change k bit values of the bitmap to 1 using k different hash functions (k being a natural number). For example, the MV2 module 331 may encode data in the form of a set into a bitmap with k representative numbers calculated by the minHash algorithm. A chunk set can be represented as a bitmap of a specific size by the MV2 module 331, and the MV2 module 331 may generate a virtual vector corresponding to a chunk set for each piece of data and represented as a bitmap. This will be described in more detail with reference to FIG. 5 and FIG. 6.

The JIG module 333 may determine similar data classified into big-groups based on a big-counter derived by accumulating virtual vectors in a fixed-size counter array. Here, the JIG module 333 may reuse one bitmap that occupies only a fixed size of memory for all pieces of data in a data stream. The JIG module 333 may measure a similarity between two pieces of data by comparing the bitmaps of the data, and may create a big-group of similar data according to the result. In particular, the JIG module 333 may perform an identification operation on big-groups through a new approach called Jaccard-index grouping.

More specifically, a total of n pieces of data defined as [d₀, . . . , dᵢ, . . . , dₙ₋₁] may be collected during a monitoring period. Here, each piece of data can be processed only once upon arrival, and when data dᵢ arrives, a bitmap Bᵢ[m] of size m can be created. The JIG module 333 may determine whether sg(dᵢ), which is a group of similar data, is a big-group, and if identified as a big-group, the data dᵢ can be stored in a separate space for the next step of operation. The JIG module 333 can maintain a summary of a data stream with only a small fixed memory and a limited number of hash operations and identify groups of similar data with a time and space complexity of O(1). The operation of the JIG module 333 may be composed of two steps: similarity summarization and membership-checking.

In one embodiment, the JIG module 333 may determine a counter that exceeds a preset first threshold value among counters in a counter array as a big-counter. To this end, the JIG module 333 may accumulate and store all bitmaps Bⱼ[m] for 0≤j≤i−1 in a counter array of size m. Here, the counter array may be represented as MV[m], and MV[r] may correspond to the value of an r-th counter in the counter array and may be represented as Expression 1 below.

$$M V [ r ] = {\sum }_{j = 0}^{i} {B}_{j} [ r ] , 0 \leq r \leq m - 1 \qquad [ Expression 1 ]$$

That is, MV[m] may be used to summarize the data stream after each piece of data is represented as a virtual vector. For data dᵢ, all data dⱼ∈sg(dᵢ), 0≤j≤i−1 may share at least

$$\frac{{θ}_{J} \times ( \vert CDC ( {d}_{i} ) \vert + \vert CDC ( {d}_{j} ) \vert )}{1 + {θ}_{J}}$$

elements in common with data dᵢ. Therefore, counters associated with sg(dᵢ) may have larger values than other counters, particularly when the Jaccard index j(dᵢ,dⱼ) between data dᵢ and data dⱼ and a big-group proportion bᵣ(dᵢ) of data dᵢ are close to 1. Here, among the counters in the counter array MV[m] for data di, a counter having a value greater than a threshold value θ_{C,i} may be determined as a big-counter.

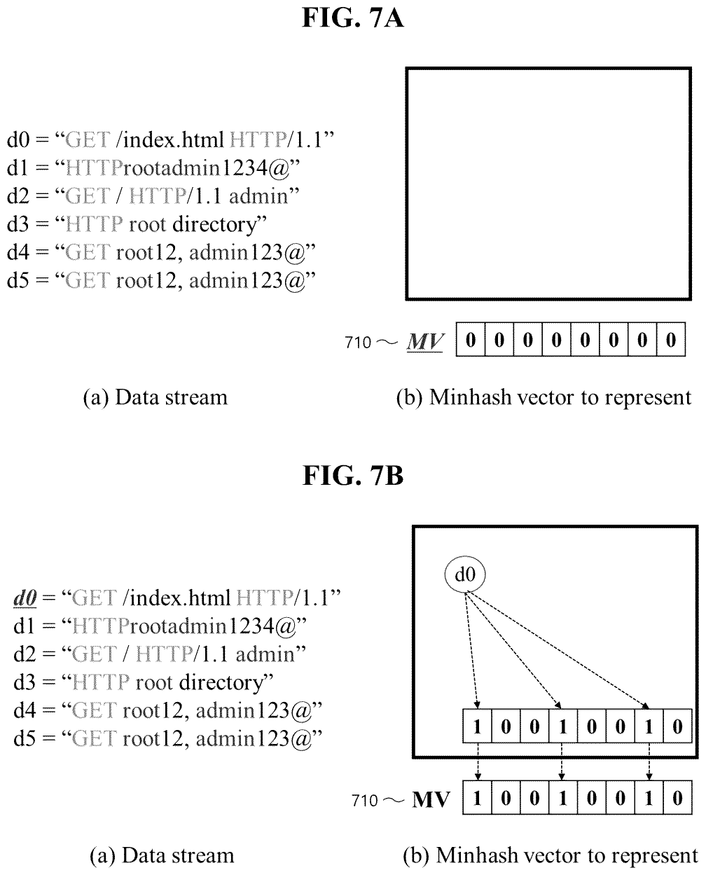

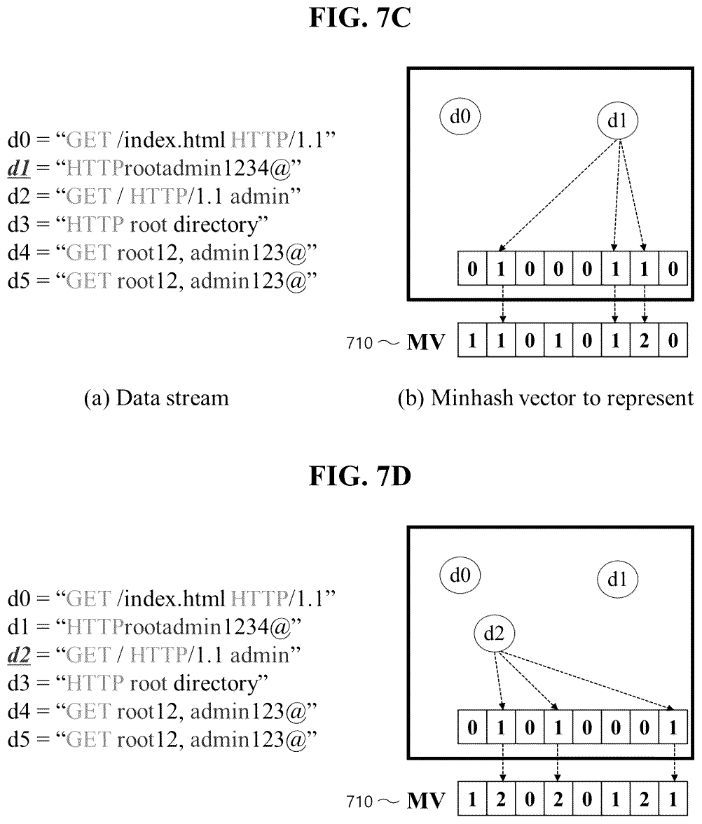

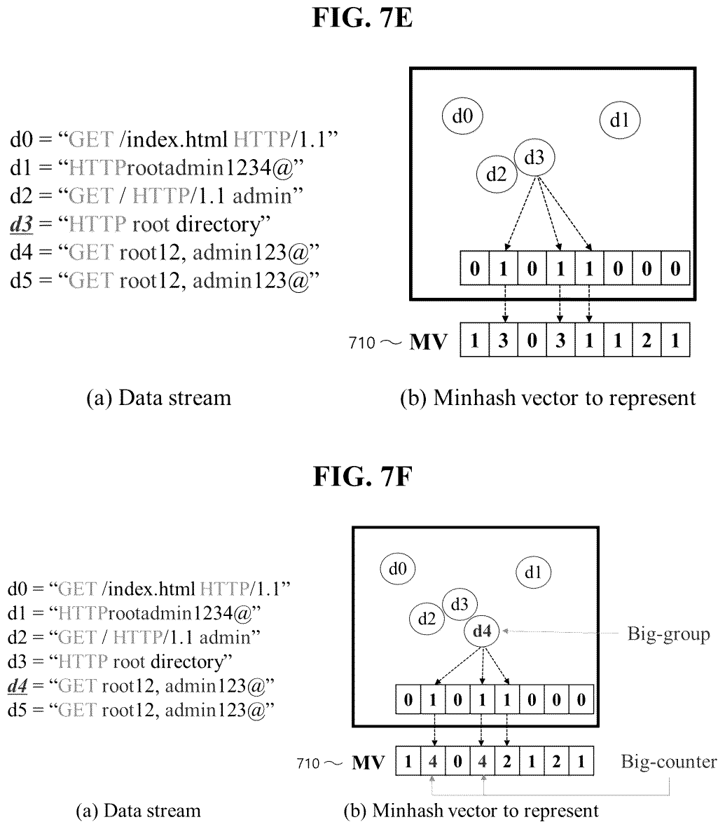

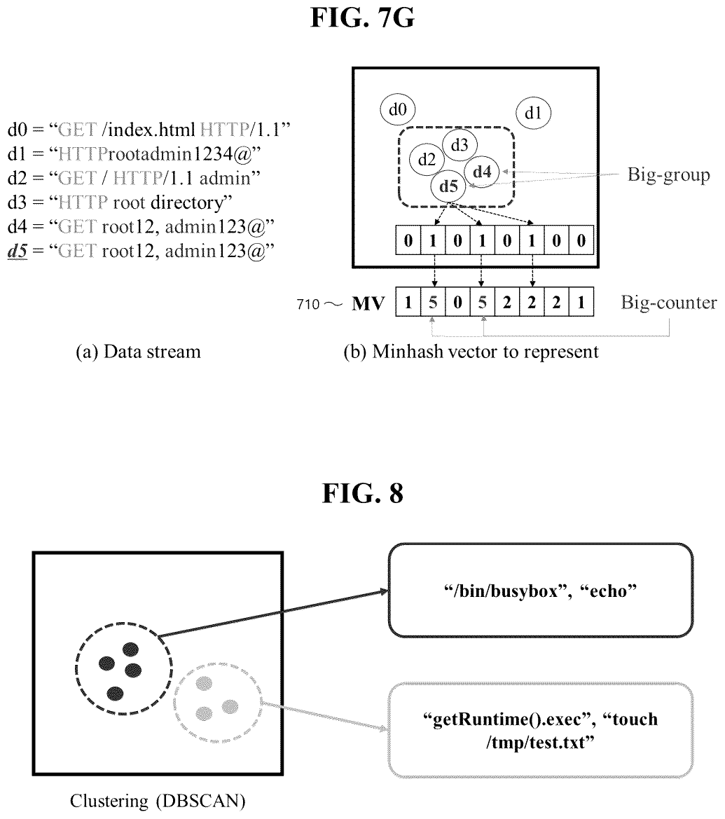

In one embodiment, the JIG module 333 may calculate the proportion of big-counters in the counter array, and when the proportion exceeds a preset second threshold value, determine data associated with a virtual vector as similar data. One of main operations of the JIG module 333 may be determining whether sg(dᵢ), which is a similar data group, is a big-group or a big-group to which data di belongs. The JIG module 333 may repeatedly perform the operation for all received data, and accordingly, low time and space complexity can be applied to the operation. The similar data classification process depending on the proportion of big-counters performed by the JIG module 333 will be described in more detail with reference to FIG. 7A to FIG. 7G.

In one embodiment, the JIG module 333 may determine a counter in a big-counter set as a big-counter as a result of repeatedly performing a first step of calculating the average and variance of counters in a counter array excluding the counters of the big-counter set, and a second step of adding counters exceeding the first threshold value calculated based on the average and variance to the big-counter set in a state in which the big-counter set has been initialized.

More specifically, the JIG module 333 may perform an operation for distinguishing a big-counter from the remaining counters for each piece of data in a data stream for big-group identification. To this end, the JIG module 333 can apply Iterative Outlier Removal Algorithm (IORA), a heuristic algorithm for finding a big-counter b_{c}(dᵢ) for data dᵢ. The JIG module 333 may generate an outlier list (OL) for big-counter identification, and the outlier list may be used as a big-counter set. That is, the outlier list can be initialized when operation on each piece of data is performed, and can be expanded by adding a big-counter at each iteration.

The core idea of IORA applied to the JIG module 333 may be that the distribution of counters that are not big-counters in the counter array MV[m] follows a normal distribution, whereas the distribution of big-counters deviates from the normal distribution. For simpler description, it can be assumed that there is only one big-group for the big group proportion of θ_{B}. Considering data that is not included in the big-group, MV[m] can be updated at a random index i×(1−θ_{B})×k times. On the other hand, k counters can be continuously updated by big-group members. When it is assumed that most data is not included in the big-group and m is 100 times larger than k, most of the counters in MV[m] may not correspond to big-counters. That is, most MV[r] can follow the binomial distribution of B(n×(1−θ_{B})×k,1/m) and can be approximated by the normal distribution represented by Expression 2 below.

$$N ( n \times ( 1 - {θ}_{B} ) \times k \times \frac{1}{m} , n \times ( 1 - {θ}_{B} ) \times k \times \frac{1}{m} \times ( 1 - \frac{1}{m} ) ) \qquad [ Expression 2 ]$$

On the other hand, k counters in the counter array MV[m] may correspond to big-counters, and their values may be much larger than other counters depending on θ_{B} and θ_{J}.

The JIG module 333 may repeatedly perform the two steps while expanding the big-

$$\begin{matrix}{μ}_{i} = \frac{{\sum }_{r = 0 , mv [ r ] ∉ OL}^{m - 1} MV [ r ]}{m - \vert OL \vert} \\ {σ}_{i}^{2} = \frac{{\sum }_{r = 0 , mv [ r ] ∉ OL}^{m - 1} {( MV [ r ] )}^{2} - {μ}_{i}^{2}}{m - \vert OL \vert}\end{matrix}$$

In the second step, the first threshold value for big-counter determination may be defined. In one embodiment, the JIG module 333 may calculate the first threshold value through Expression 4 below based on the average and variance.

$${θ}_{C , i} = {μ}_{i} + c \times {σ}_{i} \qquad [ Expression 4 ]$$

Here, θ_{C,i} is the first threshold value, μᵢ and σᵢ are the average and variance, and c is a tuning parameter. That is, if MV[r]>μᵢ+c×σᵢ, MV[r] may be regarded as an outlier and added to the big-counter set. If an outlier greater than the first threshold value is detected, the JIG module 333 may add the corresponding counter to the big-counter set and repeatedly perform the first and second steps. If no outliers are detected, the JIG module 333 may terminate repetition and determine the counters in the big-counter set as big-counters.

The signature generator 350 may generate a signature group by extracting signatures for at least one big-group. When big-group identification is completed by the big-group identification unit 330, the signature generator 350 may extract signatures by applying an existing signature generation method to the corresponding big-group. That is, the signature generator 350 may selectively generate a signature for intrusion detection only for a big-group composed of very similar data in a data stream. Accordingly, as a result of robust signatures generated for each big-group, a signature group corresponding to a set of signatures can be independently created.

For example, the Triple-Heavy-Hitter (THH) method, which extracts the most frequently occurring substring as a signature, can be applied as a signature generation method. As the THH method is designed for string data, it can be applied directly to big-groups if data di is of byte sequence type (e.g. packet or text).

In one embodiment, the signature generator 350 may include independent modules that perform operations for signature creation. That is, the signature generator 350 may include a signature-group generation (SG2) module 351 and an automatic whitelisting (AWL) module 353. Here, the signature generator 350 according to an embodiment of the present disclosure does not need to include all of the above modules simultaneously, and depending on each embodiment, some of the above modules may be omitted or some or all of the above modules may be selectively included.

The SG2 module 351 may generate a signature group for each cluster by applying a clustering algorithm to similar data identified as at least one big-group. During the JIG process performed by the JIG module 333, data identified as members of the big-group may be stored in a separate space S. Here, only members of the same big-group may be stored in S, but in some cases, there may be one or more big-groups. Therefore, the SG2 module 351 may distinguish big- groups by applying a clustering algorithm to the data stored in S. Since a relatively small number of data is stored in S and the distance between big-groups is sufficiently long, fast clustering can be performed even with small computing resources. For example, the SG2 module 351 may perform a clustering operation using DBSCAN.

The AWL module 353 may remove normal signatures in a white list from a signature group. Since a big-group identified by the big-group identification unit 330 does not always show only attack signals, the AWL module 353 may additionally perform a filtering operation for refining signatures once more. That is, the additional filtering operation may correspond to an automatic whitelisting operation.

In one embodiment, the AWL module 353 may generate a white list by extracting normal signatures from a data set that is not identified as at least one big-group among data in a data stream. That is, it can be determined whether each piece of data in a data stream is a member of a big-group through a big-group identification process, and the AWL module 353 may apply a signature generation method (for example, the THH method) to data that is not included in the big-group.

Accordingly, the AWL module 353 can extract normal signatures that frequently occur in normal situations and create a white list, which is a set of normal signatures. Thereafter, the AWL module 353 may perform a set operation to remove a white list from the signature set generated for the big-group and may remove signatures that may cause false positives during the intrusion detection process.

The controller (not shown in FIG. 3) may control the overall operation of the intrusion detection device 130 and manage control flow or data flow between the data receiver 310, the big-group identification unit 330, and the signature generator 350.

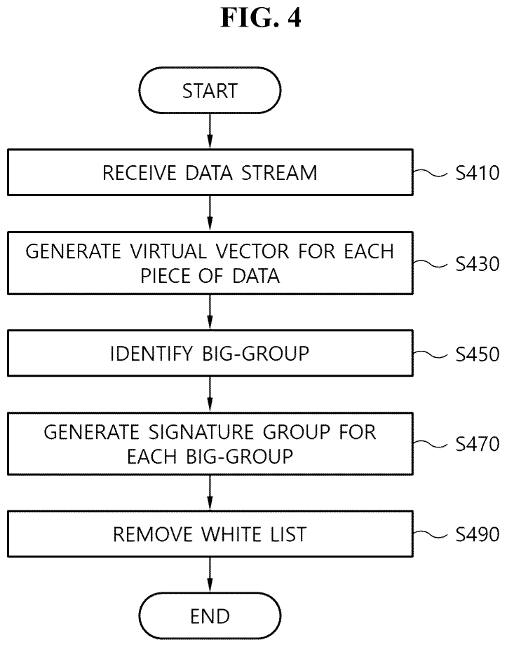

FIG. 4 is a flowchart illustrating the ultra-light clustering-based generative intrusion detection method according to the present disclosure.

Referring to FIG. 4, the intrusion detection device 130 may receive a data stream containing a specific type of data through the data receiver 310 (step S410). The intrusion detection device 130 may identify at least one big-group with respect to similar data encoded as virtual vectors based on a chunk set for each piece of data in the data stream through the big-group identification unit 330. That is, the intrusion detection device 130 may generate a virtual vector for each data unit of the data stream (step S430) and create a set of virtual vectors defined as a big-group (step S450).

Additionally, the intrusion detection device 130 may generate a signature group by extracting signatures for at least one big-group through the signature generator 350 (step S470). Thereafter, the intrusion detection device 130 may create a white list of normal signatures from a set of data other than big-groups and remove the normal signatures in the white list from the signature group (step S490).

FIG. 5 is a diagram illustrating a virtual vector generation process of the MV2 module according to the present disclosure and FIG. 6 is a diagram illustrating a minimum hash calculation process according to the present disclosure.

Referring to FIG. 5, the intrusion detection device 130 applies a different hash function to each chunk of a chunk set through the MV2 module 331 to generate virtual vectors represented as a bitmap based on the minimum value of each hash function. Here, a chunk set may be created corresponding to each piece of data in the data stream.

Specifically, the MV2 module 331 may use a minimum hash minHash to which k hash functions are applied, and hⱼ(⋅) may correspond to the j-th (0≤j≤k−1) hash function. Additionally, Bᵢ[m] may correspond to a bitmap of size m for data dᵢ and may be initialized to 0, and Bᵢ[r] may correspond to the r-th bit.

The MV2 module 331 may calculate hⱼ(x) for all x∈CDC(dᵢ) for given data dᵢ, and determine a minimum value for bitmap encoding of dᵢ and hⱼ(⋅). The MV2 module 331 may repeat the operation for all hash functions, and if there is no hash collision, k bits can be changed to 1. The encoding process for data Dᵢ may be represented as Expression 5 below.

$${B}_{i} [ ( ( {min}_{x ∈ CDC ( {d}_{i} )} {h}_{j} ( x ) ) mod m ] := 1 , 0 \leq j \leq k - 1 \qquad [ Expression 5 ]$$

Additionally, by comparing bitmaps of data, the similarity between dᵢ and dⱼ can be calculated. If m is sufficiently greater than k, the Jaccard index j(dᵢ,dⱼ) between the data can be estimated as represented by Expression 6 below.

$$j ( {d}_{i} , {d}_{j} ) = \frac{\vert CDC ( {d}_{i} ) ⋂ CDC ( {d}_{j} ) \vert}{\vert CDC ( {d}_{i} ) ⋃ CDC ( {d}_{j} ) \vert} \approx \frac{{\sum }_{r = 0}^{m - 1} ( {B}_{i} [ r ] ∧ {B}_{j} [ r ] )}{{\sum }_{r = 0}^{m - 1} ( {B}_{i} [ r ] ∨ {B}_{j} [ r ] )} \qquad [ Expression 6 ]$$

Here, ∧ and ∨ are bitwise OR and AND operators.

In FIG. 5, a virtual vector (Minhashed virtual-vector) of (0,1,0,1,1,0,0,0) as a result of the minimum hash operation using k=3, that is, three hash functions, for a set of strings {“HTTP”, “root”, “admin”, “1234@”} extracted from a payload through content definition chunking can be generated.

Referring to FIG. 6, a total of three hash functions defined as h₀, h₁, and h₂ may be applied to the string set in FIG. 5, and hash values can be calculated for all chunks. The MV2 module 331 may determine 3, 1, and 4 as minimum values for the hash functions and may generate a virtual vector based on the determined minimum values. That is, the virtual vector in FIG. 5 may correspond to a result in which the values of the second, fourth, and fifth bits corresponding to the values of 1, 3, and 4 are represented as 1.

FIG. 7A to FIG. 7G are diagrams illustrating the big-group identification process of the JIG module according to the present disclosure.

Referring to FIG. 7A to FIG. 7G, the JIG module 333 may determine similar data classified as a big-group based on a big-counter derived by accumulating virtual vectors in a fixed- size counter array. Here, the JIG module 333 may reuse one bitmap 710 which occupies only a fixed-size memory for all data in a data stream.

Meanwhile, if all bitmaps Bⱼ[m] for 0≤j≤i are maintained, it can be easily determined whether sg(dᵢ), defined by Expression 7 below, is a big-group through comparison of dᵢ and dⱼ.

$$s g ( {d}_{i} ) = \{ {d}_{j} \vert j ( {d}_{i} , {d}_{j} ) > {θ}_{J} \} ⋃ \{ {d}_{i} \} \qquad [ Expression 7 ]$$

However, this operation may be impossible for streaming data because all previous data or at least the bitmaps Bⱼ[m] need to be stored for 0≤j≤i−1.

Accordingly, the JIG module 333 can identify a big-group by applying Jaccard Index Grouping (JIG), a new approach. That is, the JIG module 333 can calculate a proportion of big-counters based on the result of virtual vector accumulation of the bitmap 710 and identify a big-group based thereon.

Specifically, when data di arrives, a bitmap Bᵢ[m] is generated, and MV[m] can be updated according to Bᵢ[m] using Expression 1. “1” bit k-index information can be obtained from Bᵢ[m], {(min_{x∈CDC(D}_{ᵢ}₎ hⱼ(x)) mod m|0<j<k−1}. k counters of dᵢ may be represented as kc(dᵢ), which is defined as Expression 8 below.

$$k c ( {d}_{i} ) = \{ M V [ ( {min}_{x ∈ CDC ( {d}_{i} )} {h}_{j} ( x ) ) mod m ] \vert 0 \leq j \leq k - 1 \} \qquad [ Expression 8 ]$$

Additionally, a big-counter represented as bc(dᵢ) may be selected from kc(dᵢ) and defined as Expression 9 below.

$$b c ( {d}_{i} ) = \{ x \vert x ∈ k c ( {d}_{i} ) , x > {θ}_{C , i} \} \qquad [ Expression 9 ]$$

Here, if dᵢ is a member of a big-group and there are sufficient members of the same big-group, many counters in kc(dᵢ) may have values much larger than other counters randomly selected from MV[m]. In particular, if θ_{J} and θ_{B} are close to 1, most counters from kc(dᵢ) are big-counters or may have much larger values than other counters.

Accordingly, the JIG module 333 may calculate the proportion of big-counters of kc(dᵢ) with respect to k, bk(dᵢ), after MV[m] is updated to dᵢ. The JIG module 333 may estimate that dᵢ is a member of the big-group if the proportion is greater than the threshold value θ_{J}, and the proportion may be represented as Expression 10 below.

$${b}_{k} ( {d}_{i} ) = \frac{\vert bc ( {d}_{i} ) \vert}{k} > {θ}_{J} \qquad [ Expression 10 ]$$

That is, MV[m] may store a summary of previous data and information on big-group relationships, and the JIG module 333 may use Expression 10 along with statistics observed in MV[m] and Bᵢ[m].

For example, when a series of pieces of data d0 to d5 sequentially arrive through a data stream, a virtual vector corresponding to each piece of data may be generated and sequentially accumulated and stored in one bitmap 710. That is, a virtual vector (1,0,0,1,0,0,1,0) may be generated for data d0 and stored in the bitmap 710 (FIG. 7B), and as shown in FIG. 7C to FIG. 7G, virtual vectors of data d1 to d5 may be sequentially stored in the bitmap 710.

In FIG. 7F, the bitmap 710 may be updated by d4, and as a result of selecting updated MV[1] and MV[3] exceeding the threshold value as big-counters, the proportion of the calculated big-counters bₖ(d4) exceeds the threshold value, and thus d4 can be identified as a member of the big-group. Additionally, in FIG. 7G, the bitmap 710 can be updated by d5, updated MV[1] and MV[3] exceeding the threshold value are selected as big-counters, and d5 can also be identified as a member of the big-group according to the calculated proportion of big-counters, bₖ(d5). Data d4 and d5 identified as members of the big-group may be stored in a separate space for the next step of the operation.

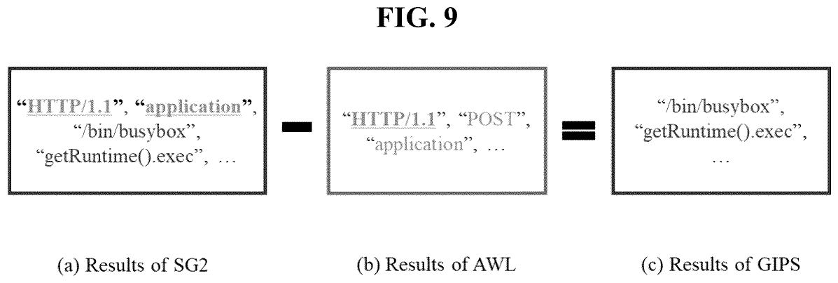

FIG. 8 is a diagram illustrating the signature generation process of the SG2 module according to the present disclosure, and FIG. 9 is a diagram illustrating the additional filtering process of the AWL module according to the present disclosure.

Referring to FIG. 8 and FIG. 9, the intrusion detection device 130 may generate a signature group by extracting signatures for at least one big-group through the signature generator 350. To this end, the signature generator 350 may include the SG2 module 351 that generates a signature group for each big-group and the AWL module 353 that performs an additional filtering operation on the signature group.

In the case of FIG. 8, the SG2 module 351 may perform a clustering operation (DBSCAN) on data identified as a big-group and perform a signature generation operation for each big-group to generate a first signature group including two signatures and a second signature group including three signatures.

In the case of FIG. 9, the AWL module 353 may perform an additional filtering operation on the signature group (Results of SG2) generated by the SG2 module 351 to refine the signature group. The AWL module 353 may extract normal signatures (Results of AWL) from data that is not identified as a big-group through AWL process and remove normal signatures included in the signature group to generate a final signature group (Results of AWL). GIPS).

Although the present disclosure has been described above with reference to preferred embodiments, those skilled in the art may modify and change the present disclosure in various manners without departing from the spirit and scope of the present disclosure as set forth in the claims below.

### DETAILED DESCRIPTION OF MAIN ELEMENTS

100: intrusion detection system
110: user terminal
130: intrusion detection device
150: database
210: processor
230: memory
250: user input/output unit
270: network input/output unit
310: data receiver
330: big-group identification unit
331: MV2 module
333: JIG module
350: signature generator
351: SG2 module
353: AWL module

1. An ultra-light clustering-based generative intrusion detection device comprising:
a data receiver configured to receive a data stream containing a specific type of data;
a big-group identification unit configured to identify at least one big-group related to similar data encoded as a virtual vector based on a chunk set for each piece of data of the data stream; and
a signature generator configured to extract signatures for each of the at least one big-group and generate a signature group.

2. The ultra-light clustering-based generative intrusion detection device of claim 1, wherein the data receiver receives a data stream with respect to any one of a plurality of types including an alert, a log, a packet, an e-mail, and a file.

3. The ultra-light clustering-based generative intrusion detection device of claim 1, wherein the big-group identification unit comprises:
a minhashed virtual-vector (MV2) module configured to generate the virtual vector represented as a bitmap based on a minimum value of each hash function by applying a different hash function to each chunk of the chunk set; and
a Jaccard-index grouping (JIG) module configured to determine the similar data classified as the big-group based on a big-counter derived by accumulating the virtual vector in a fixed-size counter array.

4. The ultra-light clustering-based generative intrusion detection device of claim 3, wherein the MV2 module changes k bit values of the bitmap to 1 using k different hash functions, where k is a natural number.

5. The ultra-light clustering-based generative intrusion detection device of claim 3, wherein the JIG module determines a counter exceeding a preset first threshold value among counters in the counter array as the big-counter.

6. The ultra-light clustering-based generative intrusion detection device of claim 5, wherein the JIG module calculates a proportion of the big-counter within the counter array and determines data associated with the virtual vector as the similar data when the proportion exceeds a preset second threshold value.

7. The ultra-light clustering-based generative intrusion detection device of claim 5, wherein the JIG module repeatedly performs a first step of calculating an average and variance of counters in the counter array excluding counters in a big-counter set in a state in which the big- counter has been initialized, and a second step of adding counters calculated based on the average and variance and exceeding the first threshold value to the big-counter set to determine a counter in the big-counter set as the big-counter.

8. The ultra-light clustering-based generative intrusion detection device of claim 7, wherein the JIG module calculates the first threshold value through the following expression based on the average and variance:
$${θ}_{C , i} = {μ}_{i} + c \times {σ}_{i}$$
wherein, θ_{C,i} is the first threshold value, μᵢ and σᵢ are the average and variance, respectively, and c is a tuning parameter.

9. The ultra-light clustering-based generative intrusion detection device of claim 1, wherein the signature generator comprises:
a signature-group generation (SG2) module configured to generate the signature group for each cluster by applying a clustering algorithm to the similar data identified as the at least one big-group; and
an automatic whitelisting (AWL) module configured to remove normal signatures in a white list from the signature group.

10. The ultra-light clustering-based generative intrusion detection device of claim 9, wherein the AWL module generates the white list by extracting the normal signatures from a data set that is not identified as the at least one big-group among the data of the data stream.

11. An ultra-light clustering-based generative intrusion detection method performed by an intrusion detection device, comprising:
receiving, by a data receiver, a data stream containing a specific type of data;
identifying, by a big-group identification unit, at least one big-group related to similar data encoded as a virtual vector based on a chunk set for each piece of data of the data stream; and
generating, by a signature generator, a signature group by extracting signatures for each of the at least one big-group.

12. The ultra-light clustering-based generative intrusion detection method of claim 11, wherein the identifying at least one big-group comprises:
generating, by a minhashed virtual-vector (MV2) module, the virtual vector represented as a bitmap based on a minimum value of each hash function by applying a different hash function to each chunk of the chunk set; and
determining, by a Jaccard-index grouping (JIG) module, the similar data classified as the big-group based on a big-counter derived by accumulating the virtual vector in a fixed-size counter array.

13. The ultra-light clustering-based generative intrusion detection method of claim 12, wherein the determining the similar data comprises determining a counter exceeding a preset first threshold value among counters in the counter array as the big-counter.

14. The ultra-light clustering-based generative intrusion detection method of claim 13, wherein the determining as the big-counter comprises:
a first step of initializing a big-counter set;
a second step of calculating an average and variance of counters in the counter array excluding counters in the big-counter set;
a third step of adding counters calculated based on the average and variance and exceeding the first threshold value to the big-counter set; and
a fourth step of determining a counter in the big-counter set as the big-counter by repeatedly performing the second and third steps until no new counter is inserted into the big-counter set.

15. A computer-readable recording medium storing a computer program including instructions for performing an intrusion detection method comprising:
receiving a data stream containing a specific type of data;
identifying at least one big-group related to similar data encoded as a virtual vector based on a chunk set for each piece of data of the data stream; and
generating a signature group by extracting signatures for each of the at least one big-group.
